(19) United States
(12) Patent Application Publication
(10) Pub. No.: US 2009/0207124 A1
(43) Pub. Date: Aug. 20, 2009

(54) DISPLAY DEVICE AND PORTABLE TERMINAL HAVING THE SAME

(76) Inventors: Jong-Woung PARK, Seongnam-si (KR); Hyung-Guel Kim, Yongin-si (KR); Kee-Han Uh, Yongin-si (KR)

Correspondence Address: Haynes and Boone, LLP;IP Section, 2323 Victory Avenue, SUITE 700, Dallas, TX, 75219, US

(21) Appl. No.: 12/331,215

(22) Filed: Dec. 9, 2008

(30) Foreign Application Priority Data
Feb. 14, 2008 (KR) 10-2008-0013601

(51) Int. Cl. G09G 3/36

(52) U.S. Cl. 345/102

(57) ABSTRACT

In accordance with one or more embodiments of the present disclosure, a display device includes a driver, a main display panel that receives an image signal from the driver to display an image and that is substantially fixed to the driver, a backlight assembly that is disposed between the main display panel and the driver to radiate light to a rear surface of the main display panel, and a sub-display panel that receives a image signal from the driver to display an image and that can be moved. The display device includes a first mode, in which the sub-display panel is disposed to be opposite to a rear surface of the main display panel, and a second mode, in which the sub-display panel is disposed to be opposite to a front surface of the main display panel.

### CROSS-REFERENCE TO RELATED APPLICATIONS

This application claims priority to and the benefit of Korean Patent Application No. 10-2008-0013601, filed in the Korean Intellectual Property Office on Feb. 14, 2008, the entire contents of which are incorporated herein by reference.

### BACKGROUND

1. Technical Field

The present invention relates to a display device and a portable terminal having the same.

2. Related Art

Several kinds of display devices exist. Due to rapid development of semiconductor technology, a display device having a liquid crystal display (LCD) panel with improved performance and a decreased size and weight is preferred.

Because a display device having a LCD panel has advantages, such as a decrease in size, thickness, and power consumption, the LCD type display device overcomes drawbacks of existing cathode-ray tube (CRT) type display devices. Presently, the LCD type display device is mounted in and used for monitors and TVs, which include medium-sized and large-sized products, as well as small-sized products, such as mobile phones, personal digital assistants (PDA), and portable multimedia players (PMP) that utilize the LCD type display device. Generally, the LCD type display device is mounted in and used for many information processing appliances that utilize a display device.

Recently, a pair of overlapping LCD panels in a display device has been adapted to display a three-dimensional (3D) image. However, by using a pair of overlapping LCD panels, the transmittance of light passing through the LCD panels may be substantially deteriorated, wherein the brightness of a displayed image may decrease.

Particularly, when the 3D type display device displays a two-dimensional (2D) image, using the pair of overlapping LCD panels is inefficient because the brightness of an image that is displayed by the 3D type of display device is unnecessarily decreased.

The above information disclosed in this Background section is only to enhance understanding of the background of the present disclosure, and therefore, it may include information that may not form the prior art that is already known in this country to a person of ordinary skill in the art.

### SUMMARY

An exemplary embodiment of the present disclosure provides a display device including: a driver; a main display panel adapted to receive an image signal from the driver to display an image and adapted to be substantially fixed to the driver; a backlight assembly disposed between the main display panel and the driver and adapted to radiate light to a rear surface of the main display panel; and a sub-display panel adapted to receive an image signal from the driver to display an image with the sub-display panel adapted to be moveable, wherein the display device has a first mode in which the sub-display panel is disposed to be opposite to a rear surface of the main display panel, and wherein a second mode in which the sub-display panel is disposed to be opposite to a front surface of the main display panel.

In the first mode, the backlight assembly and the driver may be positioned between the main display panel and the sub-display panel; and in the second mode, the main display panel and the backlight assembly may be positioned between the sub-display panel and the driver.

The display device may further include a first main polarizer and a second main polarizer that are attached to a rear surface and a front surface of the main display panel, respectively, and a first sub-polarizer and a second sub-polarizer that are attached to a rear surface and a front surface of the sub-display panel, respectively, wherein, in the second mode, a polarization axis of one of the first sub-polarizer and the second sub-polarizer opposite to the second main polarizer that is attached to the front surface of the main display panel may coincide with that of the second main polarizer.

The main display panel may be one of a transmissive display panel including transmissive pixel electrodes and a transflective display panel including transflective pixel electrodes, and the sub-display panel may be a transflective display panel including transflective pixel electrodes.

In the first mode, the main display panel may receive light from the backlight assembly to display an image in a first direction that advances from the backlight assembly to the main display panel, and the sub-display panel may reflect external light to display an image in a second direction opposite to the first direction; and in the second mode, both the main display panel and the sub-display panel may receive light from the backlight assembly to display an image in the first direction.

In the first mode, each of the main display panel and the sub-display panel may display a two-dimensional-biased image in different directions; and in the second mode, both the main display panel and the sub-display panel may be overlapped to display a three-dimensional-biased image in the same direction.

In the backlight assembly, an amount of light that is supplied to a rear surface of the main display panel may be greater in the second mode than in the first mode.

The main display panel may be one of a transmissive display panel including transmissive pixel electrodes and a transflective display panel including transflective pixel electrodes, and the sub-display panel may be a transmissive display panel including transmissive pixel electrodes.

In the first mode, the main display panel may receive light from the backlight assembly to display an image, and the sub-display panel may not display an image; and in the second mode, both the main display panel and the sub-display panel may receive light from the backlight assembly to display an image.

In the first mode, the main display panel may display a two-dimensional-biased image; and in the second mode, both the main display panel and the sub-display panel may be overlapped to display a three-dimensional-biased image in the same direction.

In the backlight assembly, an amount of light that is supplied to a rear surface of the main display panel may be greater in the second mode than in the first mode.

The display device may further include a front light assembly that is positioned between the sub-display panel and the driver in the first mode and that is positioned on a surface opposite to a surface of the sub-display panel opposite to the main display panel in the second mode, wherein the front light assembly may supply light to the sub-display panel in the first mode and pass through an image that is formed by both the main display panel and the sub-display panel in the second mode.

The main display panel may be one of a transmissive display panel including transmissive pixel electrodes and a transflective display panel including transflective pixel electrodes, and the sub-display panel may be a transmissive display panel including transmissive pixel electrodes.

In the first mode, the main display panel may receive light from the backlight assembly to display an image in a first direction that advances from the backlight assembly to the main display panel, and the sub-display panel may receive light from the front light assembly to display an image in a second direction opposite to the first direction; and in the second mode, both the main display panel and the sub-display panel may receive light from the backlight assembly to display an image in the first direction.

In the first mode, each of the main display panel and the sub-display panel may display a two-dimensional-biased image in different directions; and in the second mode, both the main display panel and the sub-display panel may be overlapped to display a three-dimensional-biased image in the same direction.

In the backlight assembly, an amount of light that is supplied to a rear surface of the main display panel may be greater in the second mode than in the first mode.

The display device may further include a hinge member that is disposed at an edge of the driver, wherein the sub-display panel may be rotated by the hinge member.

Another embodiment of the present disclosure provides a portable terminal including a main body and a display device that is connected to the main body. The display device includes: a driver; a main display panel adapted to receive an image signal from the driver to display an image and adapted to be substantially fixed to the driver; a backlight assembly disposed between the main display panel and the driver and adapted to radiate light from a rear surface of the main display panel; and a sub-display panel adapted to receive an image signal from the driver to display an image with the sub-display panel adapted to be moveable, wherein the portable terminal has a first mode in which the sub-display panel is disposed to be opposite to a rear surface of the main display panel, and wherein the portable terminal has a second mode in which the sub-display panel is disposed to be opposite to a front surface of the main display panel.

In the first mode, the backlight assembly and the driver may be positioned between the main display panel and the sub-display panel; and in the second mode, the main display panel and the backlight assembly may be positioned between the sub-display panel and the driver.

The main display panel may be one of a transmissive display panel including transmissive pixel electrodes and a transflective display panel including transflective pixel electrodes, and the sub-display panel may be a transflective display panel including transflective pixel electrodes.

In the first mode, the main display panel may receive light from the backlight assembly to display a two-dimensional-biased image in a first direction that advances from the backlight assembly to the main display panel, and the sub-display panel may reflect external light to display a two-dimensional-biased image in a second direction opposite to the first direction; and in the second mode, both the main display panel and the sub-display panel may receive light from the backlight assembly to display a three-dimensional-biased image in the first direction.

The main display panel may be one of a transmissive display panel including transmissive pixel electrodes and a transflective display panel including transflective pixel electrodes, and the sub-display panel may be a transflective display panel including transflective pixel electrodes.

In the first mode, the main display panel may receive light from the backlight assembly to display a two-dimensional-biased image, and the sub-display panel may not display an image; and in the second mode, both the main display panel and the sub-display panel may receive light from the backlight assembly to display a three-dimensional-biased image.

The portable terminal may further include a front light assembly that is positioned between the sub-display panel and the driver in the first mode and that is positioned on a surface opposite to a surface of the sub-display panel opposite to the main display panel in the second mode, wherein the front light assembly may supply light to the sub-display panel in the first mode and pass through an image that is formed by both the main display panel and the sub-display panel in the second mode. The main display panel may be one of a transmissive display panel including transmissive pixel electrodes and a transflective display panel including transflective pixel electrodes, and the sub-display panel may be a transmissive display panel including transmissive pixel electrodes.

In the first mode, the main display panel may receive light from the backlight assembly to display a two-dimensional-biased image in a first direction that advances from the backlight assembly to the main display panel, and the sub-display panel may receive light from the front light assembly to display a two-dimensional-biased image in a second direction opposite to the first direction; and in the second mode, both the main display panel and the sub-display panel may receive light from the backlight assembly to display a three-dimensional-biased image in the first direction.

### BRIEF DESCRIPTION OF THE DRAWINGS

FIGS. 1 and 2 are cross-sectional views of a display device according to a first exemplary embodiment of the present disclosure.

FIGS. 3 and 4 are layout views illustrating a pixel electrode that is used for a sub-display panel of FIG. 1.

FIG. 5 is a layout view illustrating a pixel electrode that is used for a sub-display panel of a display device according to a second exemplary embodiment of the present disclosure.

FIGS. 6 and 7 are cross-sectional views of a display device according to a third exemplary embodiment of the present disclosure.

FIGS. 8 and 9 are cross-sectional views illustrating an application example of a display device according to the present disclosure.

### DETAILED DESCRIPTION OF EMBODIMENTS

Several exemplary embodiments according to the present disclosure are described hereinafter in detail with reference to the accompanying drawings to be easily executed by a person of ordinary skill in the art. The present invention can be embodied in several different forms, and is not limited to exemplary embodiments that are described herein.

Further, in the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In exemplary embodiments according to the present disclosure, as a display panel, an LCD panel is described. A structure of the display panel is not limited to that of the LCD panel that is described in exemplary embodiments according to the present disclosure, and the display panel can have various known structures within a range that can be easily changed by a person of ordinary skill in the art.

The drawings and description are to be regarded as illustrative in nature and not restrictive. Like reference numerals designate like elements throughout the specification.

In several exemplary embodiments, the same elements are denoted by the same reference numerals and are representatively described in the first exemplary embodiment, and in other exemplary embodiments, elements different from those of the first exemplary embodiment are described.

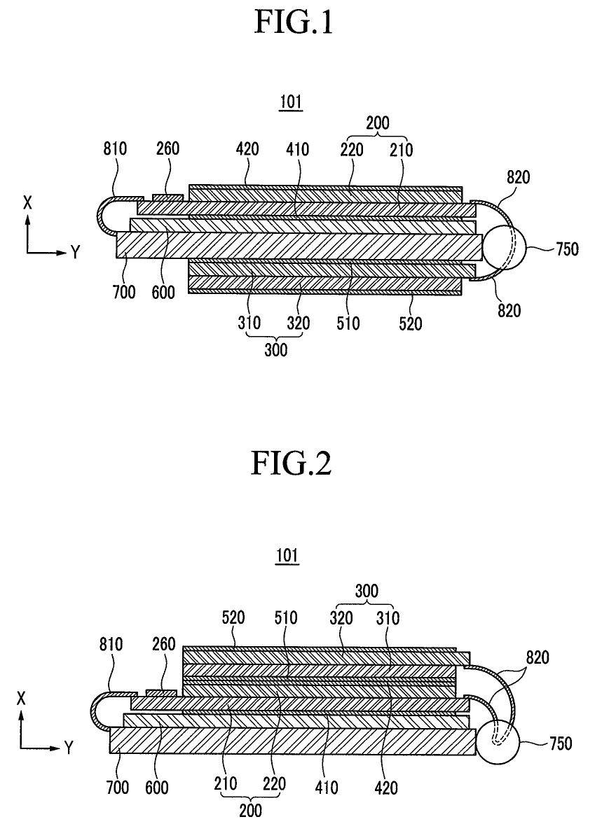

A first exemplary embodiment according to the present disclosure is described with reference to FIGS. 1 to 3. FIGS. 1 and 2 are cross-sectional views of a display device 101 according to a first exemplary embodiment of the present disclosure.

As shown in FIGS. 1 and 2, the display device 101 includes a driver 700, a main display panel 200, a sub-display panel 300, and a backlight assembly 600. The display device 101 includes a first main polarizer 410 and a second main polarizer 420 that are attached to a rear surface and a front surface of the main display panel 200, respectively, and a first sub-polarizer 510 and a second sub-polarizer 520 that are attached to a rear surface and a front surface of the sub-display panel 300, respectively. The display device 101 includes a first flexible printed circuit board (FPCB) 810, a second FPCB 820, an integrated circuit (IC) chip 260, a hinge member 750, and other necessary constituent elements. Although not shown, the display device 101 may include a reception member and a support member that receive and support the driver 700, the main display panel 200, the sub-display panel 300, the backlight assembly 600, etc.

The driver 700 supplies an image signal to the main display panel 200 and the sub-display panel 300. The driver 700 is electrically connected to the main display panel 200 through the first FPCB 810. The sub-display panel 300 is electrically connected to the main display panel 200 through the second FPCB 820. That is, the sub-display panel 300 receives an image signal from the driver 700 via the main display panel 200. However, the present disclosure is not limited thereto. Therefore, the sub-display panel 300 may be directly connected to the driver 700.

The main display panel 200 is substantially fixed to the driver 700 to display an image according to an image signal that is received from the driver 700. The sub-display panel 300 is movably disposed to display an image according to an image signal that is received from the driver 700. Each of the main display panel 200 and the sub-display panel 300 displays an image through a plurality of pixels (a pixel is a minimum unit for displaying a screen). The backlight assembly 600 is disposed between the main display panel 200 and the driver 700 to radiate light to a rear surface of the main display panel 200.

The display device 101 is operated in a first mode and a second mode according to a position of the sub-display panel 300. When displaying a two-dimensional-biased image, the display device 101 is operated in the first mode, and when displaying a three-dimensional-biased image, the display device 101 is operated in the second mode.

In the first mode, as shown in FIG. 1, the sub-display panel 300 is disposed to be opposite to a rear surface of the main display panel 200. That is, in the first mode, the backlight assembly 600 and the driver 700 are positioned between the main display panel 200 and the sub-display panel 300.

In the first mode, the main display panel 200 receives light from the backlight assembly 600 to display an image in a first direction (X-axis direction) that advances from the backlight assembly 600 to the main display panel 200, and the sub-display panel 300 reflects external light to display an image in a second direction (−X-axis direction) opposite to the first direction. That is, in the first mode, each of the main display panel 200 and the sub-display panel 300 can display an image in different directions. In this case, each of the main display panel 200 and the sub-display panel 300 displays a two-dimensional-biased image.

By such a structure, the display device 10 1 may individually display a two-dimensional-biased image in at least one of the first direction and the second direction without unnecessarily reducing the brightness of an image. If the main display panel 200 and the sub-display panel 300 are overlapped to receive light from the backlight assembly 600, transmittance of light will be remarkably deteriorated. When displaying a two-dimensional-biased image, an image can be effectively displayed with only one of the display panels 200 and 300. Therefore, when the main display panel 200 and the sub-display panel 300 are used when overlapped, brightness of an image decreases. In this way, identical or different images may be individually displayed through the main display panel 200 and the sub-display panel 300, or any one image may be displayed through one of the main display panel 200 and the sub-display panel 300.

In the second mode, as shown in FIG. 2, the sub-display panel 300 is disposed to be opposite to a front surface of the main display panel 200. That is, in the second mode, the main display panel 200 and the backlight assembly 600 are positioned between the sub-display panel 300 and the driver 700.

In the second mode, both the main display panel 200 and the sub-display panel 300 receive light from the backlight assembly 600 to display an image in the first direction (X-axis direction). That is, in the second mode, the main display panel 200 and the sub-display panel 300 are overlapped to display one image in the same direction. In this case, the overlapped main display panel 200 and sub-display panel 300 display a three-dimensional-biased image.

By such a structure, the display device 101 can display a three-dimensional-biased image. In this case, the main display panel 200 and the sub-display panel 300 are overlapped to form one image. Therefore, the display device 101 may form a three-dimensional image with a higher sense of depth and reality.

However, in the second mode, because the main display panel 200 and the sub-display panel 300 are overlapped, transmittance of light is deteriorated to reduce brightness of the displayed image. Therefore, in the second mode, it is preferable to compensate brightness of the displayed image by increasing an amount of light that is supplied from the backlight assembly 600 to a rear surface of the main display panel 200. That is, the backlight assembly 600 supplies a greater amount of light to a rear surface of the main display panel 200 when the display device 101 is in the second mode than in the first mode.

The main display panel 200 includes a first main display panel 210, a second main display panel 220 that is disposed to be opposite to the first main display panel 210, and a main liquid crystal layer (not shown) that is disposed between the first main display panel 210 and the second main display panel 220. Here, the first main display panel 210 becomes a rear surface of the main display panel 200, and the second main display panel 220 becomes a front surface of the main display panel 220. The second main display panel 220 has a lesser width than the first main display panel 210. That is, the first main display panel 210 has a wider area than the second main display panel 220. Therefore, the second main display panel 220 entirely overlaps with the first main display panel 110, but the first main display panel 110 has an area that is not overlapped with the second main display panel 220.

An IC chip 260 is mounted at an edge of the first main display panel 210 that is not overlapped with the second main display panel 220, and the first FPCB 810 is connected thereto. A second FPCB 820 is connected at another edge of the first main display panel 210. The sub-display panel 300 includes a first sub-display panel 310, a second sub-display panel 320 that is disposed to be opposite to the first sub-display panel 310, and a sub-liquid crystal layer (not shown) that is disposed between the first sub-display panel 310 and the second sub-display panel 320. Here, the first sub-display panel 310 becomes a rear surface of the sub-display panel 300, and the second sub-display panel 320 becomes a front surface of the sub-display panel 300. The first sub-display panel 320 has a lesser width than the second sub-display panel 310.

The second FPCB 820 is connected at an edge of the first sub-display panel 310 that is not overlapped with the second sub-display panel 320. Therefore, in the first mode, the first sub-display panel 310 of the sub-display panel 300 is opposite to the first main display panel 210 of the main display panel 200, and in the second mode, the first sub-display panel 310 of the sub-display panel 300 is opposite to the second main display panel 220 of the main display panel 200.

An internal structure of the display panels 200 and 300 is described hereinafter while giving primary consideration to the main display panel 200. A configuration of the sub-display panel 300 different from that of the main display panel 200 is further described, and a description of the same configuration as that of the main display panel 200 is omitted.

The first main display panel 210 includes a thin film transistor (TFT), which is a switching element, and a pixel electrode that is connected to the TFT in each pixel. The second main display panel 220 includes a common electrode. A color filter is formed in one of the first main display panel 210 and the second main display panel 220. A main liquid crystal layer is disposed between the pixel electrodes of the first main display panel 210 and a common electrode of the second main display panel 220.

By such a configuration, if a thin film transistor is turned on, an electric field is formed between a pixel electrode and the common electrode. The liquid crystal array angle of a liquid crystal layer that is disposed between the first main display panel 210 and the second main display panel 220 is changed by such an electric field, and thus light transmittance is changed in respective pixels of the main display panel 200.

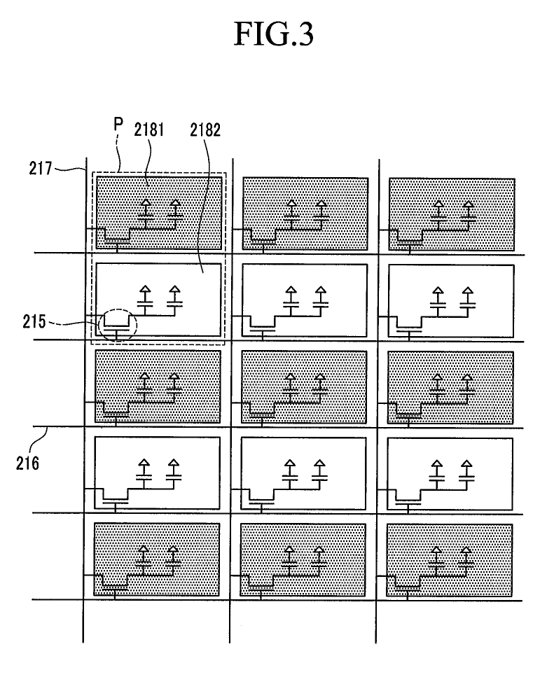

The main display panel 200 is a transmissive display panel having transparent transmissive pixel electrodes, and the sub-display panel 300 is a transflective display panel having transflective pixel electrodes. As shown in FIG. 3, the transflective pixel electrode may have a structure including transmissive pixel electrodes 2181 and reflective pixel electrodes 2182 that are separately formed. A pixel P is divided into a transmission area in which a transmissive pixel electrode 2181 is disposed and a reflection area in which a reflective pixel electrode 2182 is disposed.

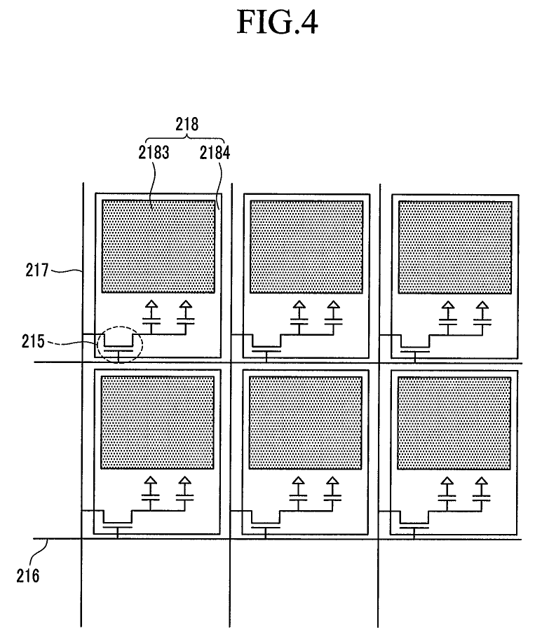

As shown in FIG. 4, in the transflective pixel electrode, a pixel electrode 218 may have a structure that has a transmissive pixel 2183 and a reflective pixel 2184. In this case, the transmissive pixel may be formed in a transparent conductor layer, and the reflective pixel may be formed in a plurality of layers including a transparent conductor and a reflective metal layer. The transparent conductor layer is made of a transparent conductive material such as indium tin oxide (ITO) or indium zinc oxide (IZO). The reflective metal layer is made of a metal having an excellent reflection ratio, such as aluminum, silver, and gold. The transflective pixel electrode is not limited to the above-described structure and may have any structure that has both a reflection area and a transmission area in one pixel.

The present disclosure is not limited to the above-described structure. Therefore, the main display panel 200 may be formed in a transflective display panel, as in the sub-display panel 300.

In FIGS. 3 and 4, reference numeral 215 indicates a thin film transistor, reference numeral 216 indicates a gate line, and reference numeral 217 indicates a data line. By such a structure, in the second mode, as both the main display panel 200 and the sub-display panel 300 adjust transmittance of light that is supplied from the backlight assembly 600, the display device 101 obtains a desired image. In this case, the sub-display panel 300 displays an image in a transmission area. Specifically, the sub-display panel 300 displays an image through the transmissive pixel electrode 2181 in the second mode, and the reflective pixel electrode 2182 displays black by applying black data.

In the first mode, as the main display panel 200 adjusts transmittance of light that is supplied from the backlight assembly 600, the display device 101 obtains a desired image, and as the sub-display panel 300 reflects external light through a reflective pixel electrode, the display device 101 displays an image in a reflection area. Specifically, in the first mode, the sub-display panel 300 displays an image through the reflective pixel electrode 2182, and the transmissive pixel electrode 2181 displays black.

An internal structure of the main display panel 200 and the sub-display panel 300 is not limited to the above-described structure, and may have various known structures within a range that may be easily changed by a person of ordinary skill in the art. For example, a thin film transistor and a pixel electrode may be formed in the second sub-display panel 310, and a common electrode may be formed in the first sub-display panel 320.

The backlight assembly 600 supplies light, and particularly visible rays, to a rear surface of the main display panel 200. As the backlight assembly 600, various known backlight assemblies that may be executed by a person of ordinary skill in the art may be used.

Polarizers (410, 420, 510, and 520) polarize visible rays that are supplied from the backlight assembly 600. It is preferable that in the second mode, a polarization axis of one of the first sub-polarizer 510 and the second sub-polarizer 520 of the sub-display panel 300 opposite to the second main polarizer 420 that is attached to a front surface of the main display panel 200, i.e., the second main display panel 220, coincides with that of the second main polarizer 420 in order to minimize the decrease of transmittance of light. This is because transmittance of light is greatly deteriorated whenever light passes through polarizers (410, 420, 510, and 520) having different polarization axes. In FIGS. 1 and 2, the second sub-polarizer 520 is opposite to the second main polarizer 420.

In one embodiment, a hinge member 750 is disposed to an edge of the driver 700 such that the sub-display panel 300 rotates to be opposite to a front surfaces or a rear surface of the main display panel 200 through the hinge member 750. By such a configuration, the display device 101 may efficiently and selectively display a two-dimensional image and a three-dimensional image. That is, the display device 101 may increase utilization efficiency of light and reduce consumptive elements when displaying a two-dimensional image. As such, the display device 101 may display a three-dimensional image with a higher sense of depth and reality.

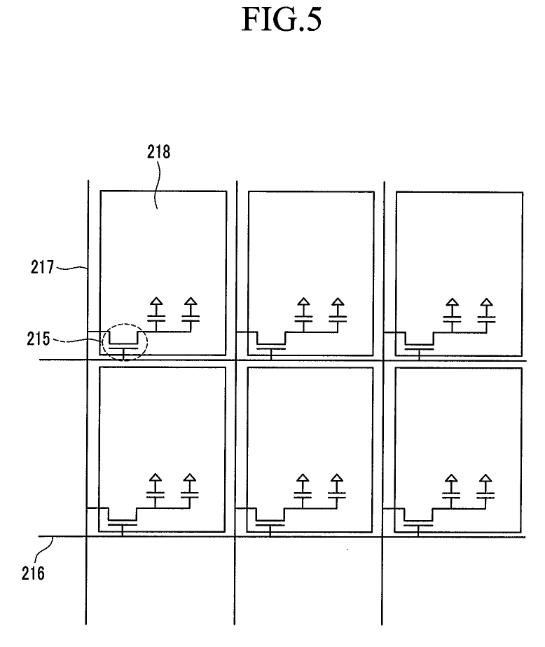

A second exemplary embodiment according to the present disclosure is described with reference to FIGS. 1, 2, and 5. As shown in FIG. 5, except for the sub-display panel 300 having only a transparent transmissive pixel electrode 218, a display device according to the second exemplary embodiment of the present disclosure has the same configuration as that of the display device of the first exemplary embodiment.

In the display device according to the first exemplary embodiment, the sub-display panel 300 has both a transmissive pixel electrode 2181 and an opaque reflective pixel electrode 2182, and a pixel is divided into a transmission area in which the transmissive pixel electrode 2181 is disposed and a reflection area in which the reflective pixel electrode 2182 is disposed.

In the first mode, the main display panel 200 receives light from the backlight assembly 600 to display an image, and the sub-display panel 300 does not display an image. That is, the display device displays an image in only a first direction but does not display an image in a second direction. In this case, the main display panel 200 displays a two-dimensional-biased image.

In the second mode, both the main display panel 200 and the sub-display panel 300 receive light from the backlight assembly 600 to display an image. That is, in the second mode, both the main display panel 200 and the sub-display panel 300 are overlapped to display one image in the same direction, i.e., a first direction. In this case, the overlapped main display panel 200 and the sub-display panel 300 display a three-dimensional-biased image. However, in the second mode, because the main display panel 200 and the sub-display panel 300 are overlapped, transmittance of light is deteriorated and thus brightness of the displayed image may be reduced. Therefore, in the second mode, an amount of light that is supplied from the backlight assembly 600 to a rear surface of the main display panel 200 is increased. That is, the backlight assembly 600 supplies a greater amount of light to a rear surface of the main display panel 200 when the display device is in the second mode than in the first mode.

By such a structure, when displaying a three-dimensional-biased image in the second mode, because the main display panel 200 and the sub-display panel 300 overlap, deterioration of transmittance of light is minimized, whereby brightness of a displaying image is further secured. In the first exemplary embodiment, because the sub-display panel 300 includes a reflective pixel electrode 2182, transmittance of light is further deteriorated by an area of the reflective pixel electrode 2182. However, in the second exemplary embodiment, because the sub-display panel 300 includes only the transmissive pixel electrode 218, deterioration of light transmittance may be further suppressed, compared with the first exemplary embodiment.

Because the sub-display panel 300 cannot use external light in the first mode, light is not supplied and thus an image cannot be substantially displayed. Therefore, the display device according to the second exemplary embodiment of the present disclosure has an advantage when selectively displaying a two-dimensional-biased image and a three-dimensional-biased image in only one direction.

By such a configuration, the display device may efficiently and selectively display a two-dimensional image and a three-dimensional image. That is, the display device may increase utilization efficiency of light when displaying a two-dimensional image and reduce consumptive elements. The display device may display a three-dimensional image with a higher sense of depth and reality.

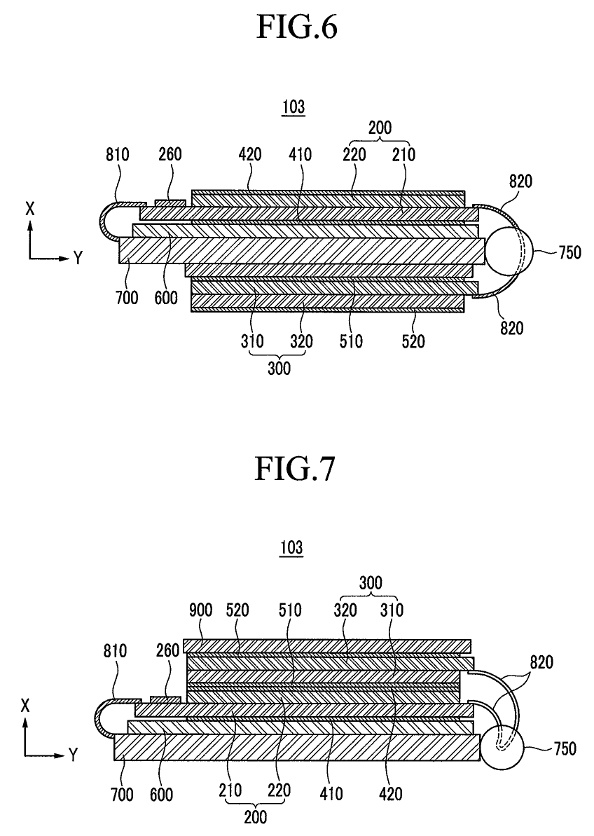

A third exemplary embodiment according to the present disclosure is described with reference to FIGS. 6 and 7. FIGS. 6 and 7 are cross-sectional views of a display device 103 according to a third exemplary embodiment of the present disclosure.

As shown in FIGS. 6 and 7, the display device 103 further includes a front light assembly 900 that is positioned between the sub-display panel 300 and the driver 700 in the first mode and that is positioned on a surface opposite to a surface of the sub-display panel 300 opposite to the main display panel 200 in the second mode.

In the first mode, as shown in FIG. 6, the main display panel 200 receives light from the backlight assembly 600 to display an image in a first direction (X-axis direction) that advances from the backlight assembly 600 to the main display panel 200, and the sub-display panel 300 receives light from the front light assembly 900 to display an image in a second direction (-X-axis direction) opposite to the first direction. That is, in the first mode, each of the main display panel 200 and the sub-display panel 300 may display an image in different directions. In this case, each of the main display panel 200 and the sub-display panel 300 displays a two-dimensional-biased image.

In the second mode, as shown in FIG. 7, both the main display panel 200 and the sub-display panel 300 receive light from the backlight assembly 600 to display an image in the first direction. That is, in the second mode, the main display panel 200 and the sub-display panel 300 are overlapped to display one image in the same direction. In this case, an image that is formed by both the main display panel 200 and the sub-display panel 300 may be viewed through the front light assembly 900. That is, the front light assembly 900 passes through an image that is formed by both the main display panel 200 and the sub-display panel 300. The overlapped main display panel 200 and sub-display panel 300 display a three-dimensional-biased image. However, in the second mode, because the main display panel 200 and the sub-display panel 300 are overlapped, transmittance of light is deteriorated and thus brightness of the displayed image may become dark. Therefore, in the second mode, an amount of light that is supplied from the backlight assembly 600 to a rear surface of the main display panel 200 is increased. That is, the backlight assembly 600 supplies a greater amount of light to a rear surface of the main display panel 200 when the display device 103 is in the second mode than in the first mode.

The front light assembly 900 generates light in the first mode to supply the light to the sub-display panel 300, but does not generate light in the second mode. In this way, the front light assembly 900 supplies light to the sub-display panel 300 in the first mode and passes through an image that is formed by both the main display panel 200 and the sub-display panel 300 in the second mode. The front light assembly 900 includes a transparent light guide and a light source that is positioned at a side surface of the light guide, and does not include an opaque part such as a reflection member.

The backlight assembly generally supplies light to a surface opposite to a surface in which the display panel forms an image. However, the front light assembly generally supplies light to a surface in which the display panel forms an image. That is, in a display device that generally uses the front light assembly, an image that is displayed in the display panel is viewed through the front light assembly.

However, in FIG. 6, like the backlight assembly 600, the front light assembly 900 supplies light to a surface opposite to a surface in which the sub-display panel 300 forms an image. Because the front light assembly 900 does not include a configuration such as a reflection member that the backlight assembly 600 generally has, utilization efficiency of light is relatively deteriorated. However, as shown in FIG. 7, the front light assembly 900 may pass through an image that is formed by both the main display panel 200 and the sub-display panel 300. In the display device 103, both the main display panel 200 and the sub-display panel 300 have only a transparent transmissive pixel electrode.

By such a structure, when a three-dimensional-biased image is displayed in the second mode, because the main display panel 200 and the sub-display panel 300 are overlapped, deterioration of transmittance of light is minimized and thus brightness of a displayed image may be further secured. In the first exemplary embodiment, because the sub-display panel 300 includes a reflective pixel electrode, transmittance of light is further deteriorated by an area of the reflective pixel electrode. However, in the third exemplary embodiment, because the sub-display panel 300 includes only a transmissive pixel electrode, deterioration of transmittance may be further suppressed, compared with the first exemplary embodiment.

In the first mode in the second exemplary embodiment, the sub-display panel 300 could not substantially display an image, but in the third exemplary embodiment, because light is supplied through the front light assembly 900, the sub-display panel 300 may also display an image.

By such a configuration, the display device 103 may efficiently and selectively display a two-dimensional image and a three-dimensional image. That is, the display device 103 may increase utilization efficiency of light and reduce consumptive elements when displaying a two-dimensional image. Further, the display device 103 may display a three-dimensional-biased image with a higher sense of depth and reality.

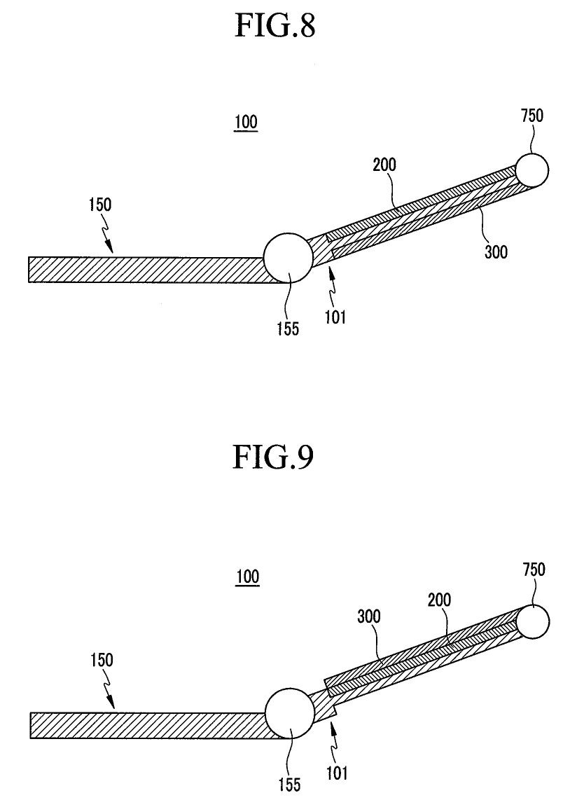

An application example of the display device 101 according to an exemplary embodiment of the present disclosure is described with reference to FIGS. 8 and 9. The display device 101 according to an exemplary embodiment of the present disclosure may be used for various fields such as an electronic display board, a monitor, or a portable terminal. FIGS. 8 and 9 show a portable terminal 100 that has the display device 101 according to an exemplary embodiment of the present disclosure.

As shown in FIGS. 8 and 9, the portable terminal 100 includes a main body 150 and a display device 101 that is connected to the main body 150. The display device 100 is opened and closed by rotating from the main body 150 about a rotation shaft 155.

When an image that is displayed in the display device 101 is a two-dimensional-biased image, as shown in FIG. 7, a user may view an image through only the main display panel 2. In this case, the sub-display panel 300 may also individually display an image. Further, even when the display device 101 is closed, i.e., when the main display panel 200 contacts the main body 150, the sub-display panel 300 may separately display an image.

When an image that is displayed in the display device 101 is a three-dimensional-biased image, as shown in FIG. 8, the user disposes the sub-display panel 300 to overlap with the main display panel 200 by rotating the sub-display panel 300 about the hinge member 750, thereby viewing a three-dimensional-biased image with a higher sense of reality.

According to the present disclosure, the display device may efficiently and selectively display a two-dimensional image and a three-dimensional image. That is, when displaying a two-dimensional image, the display device may increase utilization efficiency of light and reduce consumptive elements. Further, the display device may display a three-dimensional image with a higher sense of depth and reality.

While the present disclosure has been described in connection with what is presently considered to be practical exemplary embodiments, it is to be understood that the present disclosure is not limited to the disclosed embodiments, but, on the contrary, is intended to cover various modifications and equivalent arrangements included within the spirit and scope of the appended claims.

What is claimed is:

1. A display device comprising:
a driver;
a main display panel coupled to the driver and adapted to receive an image signal from the driver to display an image;
a backlight assembly disposed between the main display panel and the driver and adapted to radiate light to a rear surface of the main display panel; and
a sub-display panel adapted to receive an image signal from the driver and display an image with the sub-display panel adapted to be moveable,
wherein the display device has a first mode in which the sub-display panel is disposed opposite to a rear surface of the main display panel, and
wherein the display device has a second mode in which the sub-display panel is disposed opposite to a front surface of the main display panel.

2. The display device of claim 1, wherein, in the first mode, the backlight assembly and the driver are positioned between the main display panel and the sub-display panel, and wherein, in the second mode, the main display panel and the backlight assembly are positioned between the sub-display panel and the driver.

3. The display device of claim 2, further comprising:
a first main polarizer and a second main polarizer coupled to a rear surface and a front surface of the main display panel, respectively; and
a first sub-polarizer and a second sub-polarizer coupled to a rear surface and a front surface of the sub-display panel, respectively,
wherein, in the second mode, a polarization axis of one of the first sub-polarizer and the second sub-polarizer opposite to the second main polarizer that is coupled to the front surface of the main display panel coincide with that of the second main polarizer.

4. The display device of claim 2, wherein the main display panel comprises at least one of a transmissive display panel having transmissive pixel electrodes and a transflective display panel having transflective pixel electrodes, and wherein the sub-display panel comprises a transflective display panel having transflective pixel electrodes.

5. The display device of claim 4, wherein, in the first mode, the main display panel receives light from the backlight assembly to display an image in a first direction that advances from the backlight assembly to the main display panel, and the sub-display panel reflects external light to display an image in a second direction opposite to the first direction, and wherein, in the second mode, both the main display panel and the sub-display panel receive light from the backlight assembly to display an image in the first direction.

6. The display device of claim 5, wherein, in the first mode, each of the main display panel and the sub-display panel displays a two-dimensional-biased image in different directions, and wherein, in the second mode, both the main display panel and the sub-display panel are overlapped to display a three-dimensional-biased image in the same direction.

7. The display device of claim 5, wherein, in the backlight assembly, an amount of light that is supplied to a rear surface of the main display panel is greater in the second mode than in the first mode.

8. The display device of claim 2, wherein the main display panel comprises at least one of a transmissive display panel having transmissive pixel electrodes and a transflective display panel having transflective pixel electrodes, and wherein the sub-display panel comprises a transmissive display panel having transmissive pixel electrodes.

9. The display device of claim 8, wherein, in the first mode, the main display panel receives light from the backlight assembly to display an image, and the sub-display panel does not display an image, and wherein, in the second mode, both the main display panel and the sub-display panel receive light from the backlight assembly to display an image.

10. The display device of claim 9, wherein, in the first mode, the main display panel displays a two-dimensional-biased image, and wherein, in the second mode, both the main display panel and the sub-display panel are overlapped to display a three-dimensional-biased image in the same direction.

11. The display device of claim 9, wherein, in the backlight assembly, an amount of light that is supplied to a rear surface of the main display panel is greater in the second mode than in the first mode.

12. The display device of claim 2, further comprising a front light assembly that is positioned between the sub-display panel and the driver in the first mode and that is positioned on a surface opposite to a surface of the sub-display panel opposite to the main display panel in the second mode, wherein the front light assembly supplies light to the sub-display panel in the first mode and passes through an image that is formed by both the main display panel and the sub-display panel in the second mode.

13. The display device of claim 12, wherein the main display panel comprises at least one of a transmissive display panel having transmissive pixel electrodes and a transflective display panel having transflective pixel electrodes, and wherein the sub-display panel comprises a transmissive display panel having transmissive pixel electrodes.

14. The display device of claim 13, wherein, in the first mode, the main display panel receives light from the backlight assembly to display an image in a first direction that advances from the backlight assembly to the main display panel, and the sub-display panel receives light from the front light assembly to display an image in a second direction opposite to the first direction, and wherein, in the second mode, both the main display panel and the sub-display panel receive light from the backlight assembly to display an image in the first direction.

15. The display device of claim 14, wherein, in the first mode, each of the main display panel and the sub-display panel displays a two-dimensional-biased image in different directions, and wherein, in the second mode, both the main display panel and the sub-display panel are overlapped to display a three-dimensional-biased image in the same direction.

16. The display device of claim 14, wherein, in the backlight assembly, an amount of light that is supplied to a rear surface of the main display panel is greater in the second mode than in the first mode.

17. The display device of claim 1, further comprising a hinge member that is disposed at an edge of the driver, wherein the sub-display panel is rotated through the hinge member.

18. A portable terminal comprising:
a main body; and
a display device coupled to the main body,
wherein the display device comprises:
a driver;
a main display panel coupled to the driver and adapted to receive an image signal from the driver to display an image;
a backlight assembly disposed between the main display panel and the driver and adapted to radiate light from a rear surface of the main display panel; and
a sub-display panel adapted to receive an image signal from the driver to display an image with the sub-display panel adapted to be moveable,
wherein the portable terminal has a first mode in which the sub-display panel is disposed opposite to a rear surface of the main display panel, and
wherein the portable terminal has a second mode in which the sub-display panel is disposed opposite to a front surface of the main display panel.

19. The portable terminal of claim 18, wherein, in the first mode, the backlight assembly and the driver are positioned between the main display panel and the sub-display panel, and wherein, in the second mode, the main display panel and the backlight assembly are positioned between the sub-display panel and the driver.

20. The portable terminal of claim 19, wherein the main display panel comprises at least one of a transmissive display panel having transmissive pixel electrodes and a transflective display panel having transflective pixel electrodes, and wherein the sub-display panel comprises a transflective display panel having transflective pixel electrodes.

21. The portable terminal of claim 20, wherein, in the first mode, the main display panel receives light from the backlight assembly to display a two-dimensional-biased image in a first direction that advances from the backlight assembly to the main display panel, and the sub-display panel reflects external light to display a two-dimensional-biased image in a second direction opposite to the first direction, and wherein, in the second mode, both the main display panel and the sub-display panel receive light from the backlight assembly to display a three-dimensional-biased image in the first direction.

22. The portable terminal of claim 19, wherein the main display panel comprises at least one of a transmissive display panel having transmissive pixel electrodes and a transflective display panel having transflective pixel electrodes, and wherein the sub-display panel comprises a transflective display panel including transflective pixel electrodes.

23. The portable terminal of claim 22, wherein, in the first mode, the main display panel receives light from the backlight assembly to display a two-dimensional-biased image and the sub-display panel does not display an image, and wherein, in the second mode, both the main display panel and the sub-display panel receive light from the backlight assembly to display a three-dimensional-biased image.

24. The portable terminal of claim 19, further comprising a front light assembly that is positioned between the sub-display panel and the driver in the first mode and that is positioned on a surface opposite to a surface of the sub-display panel opposite to the main display panel in the second mode, wherein the front light assembly supplies light to the sub-display panel in the first mode and passes through an image that is formed by both the main display panel and the sub-display panel in the second mode, and wherein the main display panel comprises at least one of a transmissive display panel having a transmissive pixel electrode and a transflective display panel having a transflective pixel electrode, and wherein the sub-display panel is a transmissive display panel having a transmissive pixel electrode.

25. The portable terminal of claim 24, wherein, in the first mode, the main display panel receives light from the backlight assembly to display a two-dimensional-biased image in a first direction that advances from the backlight assembly to the main display panel, and the sub-display panel receives light from the front light assembly to display a two-dimensional-biased image in a second direction opposite to the first direction, and wherein, in the second mode, both the main display panel and the sub-display panel receive light from the backlight assembly to display a three-dimensional-biased image in the first direction.
